(19) United States
(12) Patent Application Publication
(10) Pub. No.: US 2016/0327081 A1
(43) Pub. Date: Nov. 10, 2016

(54) SCREW, FASTENING ARRANGEMENT AND USE OF A SCREW

(71) Applicant: SFS intec Holding AG, Heerbrugg (CH)

(72) Inventors: Roland Mair, Gotzis (AT); Marco Zach, Diepoldsau (CH)

(73) Assignee: SFS intec Holding AG, Heerbrugg (CH)

(21) Appl. No.: 15/109,279

(22) PCT Filed: Jan. 19, 2015
(86) PCT No.: PCT/EP2015/050845

§ 371 Date: Jun. 30, 2016

(30) Foreign Application Priority Data
Jan. 23, 2014 (DE) 10 2014 000 940.8

(51) Int. Cl. F16B 25/00; E04B 2/00; F16B 39/30

(52) U.S. Cl. CPC F16B 25/0021; F16B 25/0047; F16B 25/0063; F16B 39/30; E04C 2/46

(57) ABSTRACT

A screw (10) having a screw head (14) equipped with an engagement portion (12), having a shaft (16) which defines a screw axis and which bears a thread (18), and having a thread-free shaft portion (20) arranged between the thread (18) and the screw head (14). A head-side end (22) of the thread (18) is truncated. Additionally, the thread (18) ends, adjacent to the thread-free shaft portion (20), in an end plane (32) which, with a constant spacing to the screw head (14), runs at least partially around the shank (16) and forms an angle α_{E} with the screw axis, and a head-side flank (34) of the thread (18) averted from the thread-free shank section (20) forms an angle α_{F} with the screw axis, and the angle α_{E} is smaller than the angle α_{F}.

### BACKGROUND

The invention relates to a screw comprising a screw head that is provided with an engagement point, a shaft that defines a screw axis and has a thread, and a thread-free shaft portion that is arranged between the thread and the screw head.

The invention further relates to a fastening arrangement and to a use of a screw according to the invention.

The present screws, fastening arrangements and uses are mainly for fastening outer or inner metal sheets of sandwich panels. The sheet stacks used in this case are intended to be securely held together by screws which are, in turn, cost-effective and can be inserted simply and quickly during use.

Fastening arrangements of the stated type are associated in particular with two problems. Firstly, a screw that has been screwed into the sheet stack should be prevented from being able to be removed again from the sheet stack by means of unintentional loosening. Secondly, it is desirable to ensure that the fit of the screw in the sheet stack is as free as possible from backlash.

A fundamental requirement for the resistance to loosening is the mentioned thread-free shaft portion between the thread and the screw head, it still being entirely permissible, however, for contact between the final thread turn and the sheet stack to remain or to occur precisely in order to provide the mentioned zero backlash or as little backlash as possible of the screw in the fastening arrangement.

### SUMMARY

The object of the invention is therefore to specify a screw and thus a fastening arrangement and a use of the screw, in which the screw is resistant to loosening and is a component of the fastening arrangement that is as free as possible from backlash. It should be possible for large tightening forces to be generated and large shearing forces to be absorbed.

This object is achieved by the independent claims. Advantageous embodiments of the invention are set out in the dependent claims.

The invention further develops the generic screw in that a head end of the thread is cut off. The thread thus does not end in the manner of a conventional thread on the side of the screw head. Conventional threads gradually peter out, usually as a result of the thread production by cold forming methods, in particular thread rolling. This means that the material protruding through the thread above the shaft gradually reduces as it nears the screw head, until a thread is no longer discernible. The thread “peters out to zero”. This is different in the screw according to the invention. In this case, the head end of the thread is cut off, i.e. said thread ends abruptly and not gradually. There is thus still a significant amount of thread material immediately beside the transition between the thread-free shaft and the thread end. The thread does not peter out to zero, but rather ends abruptly and suddenly. The resistance of the screw to loosening is thereby improved. If the thread-free shaft portion has passed through the screw hole, the cut-off end of the thread makes loosening difficult. In a conventional screw, in which the thread gradually peters out to zero, loosening of the screw is promoted, since there is virtually no resistance to be overcome at the start of the engagement between the thread and the adjacent layer of the fastening arrangement, and there are no specific positions that would prevent the thread from re-engaging in the layers of the fastening arrangement. Minimal force in the return direction and loosening of the screw are sufficient to remove the screw again from the fastening arrangement, since the head thread end of said screw easily engages in the layers of the fastening arrangement. This is different in the screw according to the invention. In this case, the head end of the thread is cut off, with the result that it is far less likely, when the screw is withdrawn and loosened, that the thread end will engage in the stack of the fastening arrangement. Vibrations or other external influences will definitely not result in loss of the screw having the cut-off thread, but this can certainly occur in conventional screws and the “asymptotic” manner in which the thread peters out.

Rather more specially, the invention is particularly advantageously developed in that, remote from the thread-free shaft portion, the thread has a defined thread depth, and in that the head end of the thread forms a shoulder to the shaft that has a maximum radial height at a starting point that is greater than 10% of the thread depth, preferably greater than 20% of the thread depth, preferably greater than 40% of the thread depth, preferably greater than 60% of the thread depth, preferably greater than 80% of the thread depth, and preferably 100% of the thread depth. Simply a thread shoulder to the shaft having a small radial height of approximately 10% can be sufficient for significantly improving the resistance of the screw to loosening. Depending on the type of fastening arrangement in which the screw is used, larger or smaller radial heights in the region of the shoulder may be useful or necessary. In an extreme case, the thread may be cut off at its full height. In this case, the shoulder has a maximum radial height that is 100% of the thread depth of the screw remote from the thread-free shaft portion, i.e. in the “normal region” of the thread.

It can be advantageous for the shoulder to be defined by a radial cut having an axial cutting plane. The cutting plane thus produced is therefore perpendicular on the shaft and is parallel to the screw axis. Accordingly, there is no petering-out region of the thread proceeding from the shoulder towards the screw head, which region would have a circumferential component that could, rather, promote engagement of the thread in the stack of the fastening arrangement.

It can, however, also be provided for the thread, proceeding from the starting point of the shoulder, to end in at least one non-radial end face that tapers towards the shaft. It is thus not necessary to cut off the head end of the thread in a sharp and radial manner. Rather, it is also within the scope of the invention for the thread to end having a non-radial end face that is likewise designed such that there is a larger force for screwing the screw into the fastening arrangement upon loosening and/or less likelihood thereof than in a conventional screw having a thread that peters out in an asymptotic manner.

The invention further develops the generic prior art in that the thread ends adjacently to the thread-free shaft portion in an end plane that surrounds the shaft at least in part at a constant spacing from the screw head and forms an angle α_{E} with the screw axis, in that, remote from the thread-free shaft portion, a head flank of the thread forms an angle α_{F} with the screw axis, and in that the angle α_{E} is smaller than the angle α_{F}. An end plane of this kind comes into contact with the adjacent layer of the fastening arrangement at a plurality of points on the circumference of the screw, either when there is sufficient tension in the finished state of the fastening arrangement, or when the screw is withdrawn for any reason. In each case, the “flattened” end plane improves the contact between the thread and the rest of the fastening arrangement, with the result that the backlash of the screw in the fastening arrangement is reduced.

In this context, it can be particularly preferable for the end plane to extend radially.

According to another embodiment of the invention, it is provided for the thread to have a constant pitch when tapering towards the screw head across a plurality of thread turns, and to end at a pitch of 0 after a kink. The relationships between the angles α_{E} and α_{F} result almost automatically from the “kinking” of the thread from a true thread pitch to a thread pitch of 0. The threaded part having a thread pitch of 0 can then again be formed advantageously having a cut-off head end.

The screw according to the invention is particularly advantageously developed in that the thread-free shaft portion has, at least in part, a diameter that is greater than the core diameter of the thread and smaller than the outer diameter of the thread. Since at least the outermost layer of the layer stack in which the screw is inserted is generally pre-drilled such that the screw, together with the thread thereof, can be guided through the hole without contact, the hole has a significantly greater diameter than the core of the thread. Since the thread-free shaft portion is now selected having, at least in part, a greater diameter than the core of the thread, the backlash in the hole of the outer layer is reduced.

It can also be provided for the thread-free shaft portion to have, at least in part, a diameter that is smaller than or equal to the core diameter of the thread. As a result, the thread-free shaft portion penetrates the layer arrangement in a frictionless manner.

It can be provided for the thread-free shaft portion to comprise a step, adjacent to the screw head, having a shaft diameter that is greater than the core diameter of the thread.

According to a particular embodiment of the present invention, the screw is designed such that the screw is a drilling screw having a shaft that peters out into a boring tip. If the screw is formed as a drilling screw, the layer stack can optionally be provided with pre-drilled holes in one or more layers, or even without any pre-drilled holes.

It is also possible for the screw to be a drive-out screw having a thread that extends into the tip of the drive-out screw. A drive-out screw removes essentially no material, but rather displaces the material of layers that have not been pre-drilled or have been insufficiently pre-drilled, such that funnel-like structures form when the screw is screwed in. For example, if the lowest layer of a layer arrangement has not been pre-drilled, the funnel-like structure thus forms in this lowest layer. If the length of the thread-free shaft portion, the thickness of the stack and the thickness of the screw are well matched to one another, the funnel-like structure rests, in the finished state, with the edge thereof on the final thread, i.e. in particular on the end plane of the thread, loosening of the screw nonetheless being impossible or unlikely due to, in particular, of the cut-off end of the thread.

According to a preferred embodiment, it is provided for the thread to be a tapping-screw thread.

The screw can also be selected such that the thread is a single-start or multi-start thread.

The invention further consists in a fastening arrangement comprising a layer stack having at least one thin metal sheet and a screw according to the invention, wherein the thickness of the layer stack corresponds to the maximum length of the thread-free shaft portion. In this case, the focus should in particular be the thickness of the layer stack in the end state and in the immediate vicinity of the screw, since this thickness changes when the screw is screwed in, in particular if said screw is a drive-out screw.

It is preferred for the thin metal sheet to be the layer of the layer stack that is furthest from the screw head. This thin metal sheet is suitable in particular for shaping a funnel edge by the drive-out screw being screwed in, and thus for resting the funnel edge on the thread end in an advantageous manner.

A particular advantage is that the layer that is furthest from the screw head has a maximum thickness of 1 mm. In particular the thickness of the layer that is furthest from the screw head has a significant influence on the displacement mechanism described, as a result of which specific layer thicknesses have particularly advantageous effects, in particular thicknesses of less than 1 mm or even of 0.7 mm or even of less than 0.5 mm. The method is suitable, on this basis, for attaching profiles and other superstructures that require high tightening values to facades having very thin outer layers.

Thus, the invention also consists in a use of a screw according to the invention externally or internally on a building.

In particular, the use is designed for fastening outer or inner metal sheets of sandwich panels.

### BRIEF DESCRIPTION OF THE DRAWINGS

The invention will now be explained on the basis of particularly preferred embodiments, with reference to the accompanying drawings in which:

FIG. 1 is a partially sectional partial side view of a first embodiment of a screw according to the invention;

FIG. 2 is a first detail from FIG. 1;

FIG. 3 is a second detail from FIG. 1;

FIG. 4 is a side view of a second embodiment of a screw according to the invention;

FIG. 5 is a first detail from FIG. 4;

FIG. 6 is a second detail from FIG. 4;

FIG. 7 is a side view of a third embodiment of a screw according to the invention;

FIG. 8 is a first detail from FIG. 7;

FIG. 9 is a second detail from FIG. 7;

FIG. 10 is a side view of a fourth embodiment of a screw according to the invention;

FIG. 11 is a detail from FIG. 10;

FIG. 12 is a side view of a fifth embodiment of a screw according to the invention;

FIG. 13 is a partially sectional view of a fastening arrangement according to the invention;

FIG. 14 is a side view of a sixth embodiment of a screw according to the invention; and

FIG. 15 is a detail from FIG. 14.

### DETAILED DESCRIPTION OF THE PREFERRED EMBODIMENTS

In the following description of the figures, like reference numerals denote like or similar components.

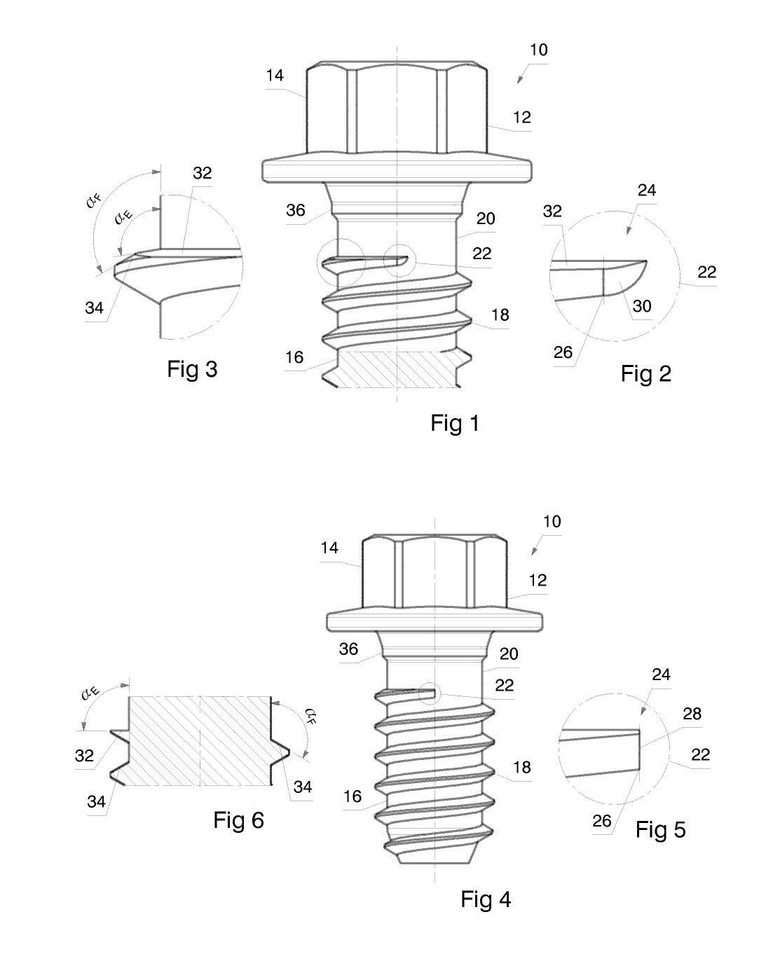

FIG. 1 is a partially sectional partial side view of a first embodiment of a screw 10 according to the invention. FIG. 2 is a first detail from FIG. 1. FIG. 3 is a second detail from FIG. 1. The screw 10 has a screw head 14 that provides an engagement point 12 for a tool. A shaft 16 is connected to the screw head 14 and, just like the screw head 14, defines an axis. The shaft 16 has a thread 18 in portions. The shaft 16 also comprises a thread-free portion 20.

The head end 22 of the thread 18 has a particular design. Unlike in conventional screws, said end does not gradually peter out in the shaft 20 in an almost asymptotic manner or “to zero”, but instead is cut off. In this sense, the head end 22 of the thread 18 has a shoulder 24, wherein the thread, proceeding from a starting point 26 of the shoulder 24, tapers in a surface 30 towards the shaft 16. In the present case, the surface 30 has a curvature. Due to the particular design of the head end 22 of the thread 18, the screw 10 is provided with particular resistance to loosening, since a radial height of the thread that exists virtually to the end of the thread makes it more difficult for the thread to engage in the other components of the fastening arrangement when the screw 10 is withdrawn and loosened.

A further particular feature of the screw 10 can be identified in the angles α_{E} and α_{F} that the end plane 32 of the thread 18 and the normal flanks 34 of the thread 18 respectively form with the screw axis. In this case, the end plane of the thread 32 encloses a smaller angle α_{E} with the screw axis than the flank 34 does in its angle α_{F}. This ensures better contact of the screw 10 with other components of the fastening arrangement, as a result of which the backlash of the screw 10 in the fastening arrangement is reduced and which also makes a positive contribution to improved resistance to loosening. In the embodiment of FIGS. 1 to 3, the angle α_{E} is slightly larger than a right angle.

FIG. 4 is a side view of a second embodiment of a screw 10 according to the invention. FIG. 5 is a first detail from FIG. 4. FIG. 6 is a second detail from FIG. 4. The screw 10 shown here corresponds, in most of its parts, to that of FIG. 1, although a further particular feature of the screw can be identified here in that said screw has a blunt end. Further differences in the screw according to FIG. 4 compared with that according to FIG. 1 relate to the head end 22 of the thread 18 and to the end plane 32 of the thread 18.

In this case, the head end 22 of the thread is defined by a radial cut having an axial cutting plane 28. This provides the main advantages in terms of resistance to loosening.

In this case, the end plane 32 of the thread encloses a right angle with the screw axis. In any case, here, too, the angle α_{E} that the end plane 32 encloses with the screw axis is greater than the angle α_{F} that an otherwise arbitrary flank 34 of the thread 18 forms with the screw axis.

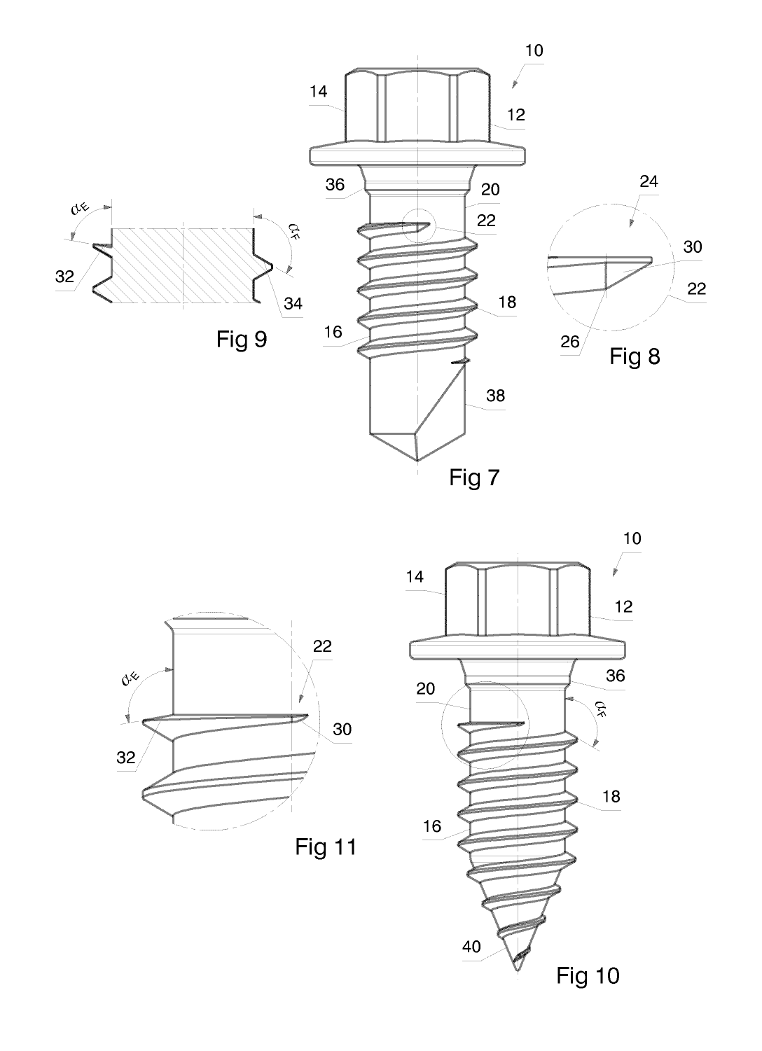

FIG. 7 is a side view of a third embodiment of a screw 10 according to the invention. FIG. 8 is a first detail from FIG. 7. FIG. 9 is a second detail from FIG. 7. Unlike the screw according to FIG. 4, the screw 10 shown here does not have a blunt end but ends in a boring tip 38. Otherwise, most of the features of the screw 10 are again identical to the screws according to FIGS. 1 and 4. In contrast to the screws described above, however, the screw 10 according to FIG. 7 has further particular properties with respect to the head end 22 of the thread 18 thereof, and to the end plane 32 of the thread.

In this case, the head end 22 of the thread 18 ends, proceeding from a starting point 26, in a plane, i.e. a surface without a curvature, that tapers towards the shaft 16.

In contrast to the screws according to FIGS. 1 and 4, the screw 10 according to FIG. 7 has an end plane 32 of the thread 18 that encloses an acute angle α_{E} with the screw axis. Once again, the angle α_{E} between the end plane and the screw axis is smaller than the angle α_{F} of an otherwise arbitrary flank 34 of the thread 18.

FIG. 10 is a side view of a fourth embodiment of a screw 10 according to the invention. FIG. 11 is a detail from FIG. 10. The screw 10 that can be seen here is a drive-out screw comprising a thread 18 that extends into the tip 40 of the screw 10. Otherwise, the screw 10 again has particular features with respect to the head end 22 of the thread 18 and the end plane 32 of the thread 18.

The head end 22 of the thread is again cut off, in a manner comparable to FIG. 1, the end surface 30 of the thread being drawn slightly longer here than in FIG. 1.

The same applies to the end plane 32 of the thread 18 as has been set out above relating to FIG. 1.

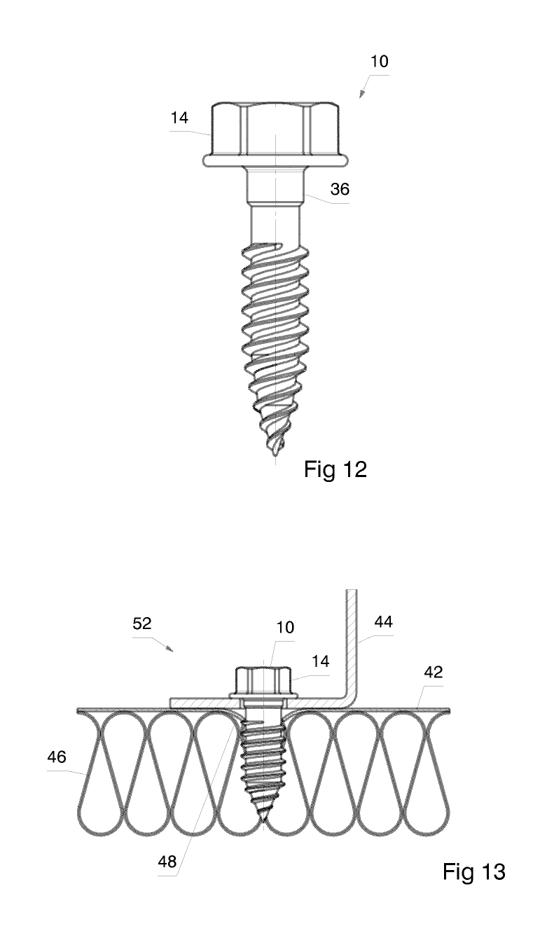

FIG. 12 is a side view of a fifth embodiment of a screw 10 according to the invention. The screw 10 according to FIG. 12 is also a drive-out screw. A particular feature to be mentioned here is that the step 36 of the shaft 16 that is adjacent to the head 14 of the screw 10 is significantly longer here than in the case of the screws described above.

FIG. 13 is a partially sectional view of a fastening arrangement 52 according to the invention. The fastening arrangement 52 comprises a thin metal sheet 42 and a further metal sheet 44 arranged thereon. The metal sheets 42, 44 form a sheet stack or layer stack 42, 44. The fastening arrangement 52 also comprises a screw 10, the screw head 14 of which rests on the outer metal sheet 44 of the sheet stack 42, 44. A shaft of the screw is guided through holes in the metal sheets 42, 44. Insulating material 46 is arranged on the thin metal sheet 42. The screw 10 is designed as a drive-out screw. When the screw 10 is screwed into the sheet stack 42, 44, the outer metal sheet 44 is pre-drilled while the thin metal sheet 42 is intact. The tip penetrates into the thin metal sheet 42 and, when the screw 10 is screwed into the sheet stack 42, 44, the thin metal sheet 42 assumes a funnel shape 48 in the vicinity of the screw 10. When the screw 10 is completely screwed into the sheet stack 42, 44, the edge of the funnel is preferably supported on the end plane of the thread, i.e. on the part of the thread that, in the context of the further figures above, is defined by its angle α_{E} with the screw axis compared with the angle α_{F} of an otherwise arbitrary flank of the thread with the screw axis. The supported situation can either always be present, or can arise only when the screw 10 is withdrawn, specifically when said screw again has a certain backlash in the fastening arrangement 52. The screw 10 obtains resistance to loosening in that the head end of the thread 18 is designed as described in conjunction with the further figures above. As a result, it is made more difficult or less likely for the screw 10 to penetrate into the funnel edge 48 when the screw 10 is loosened.

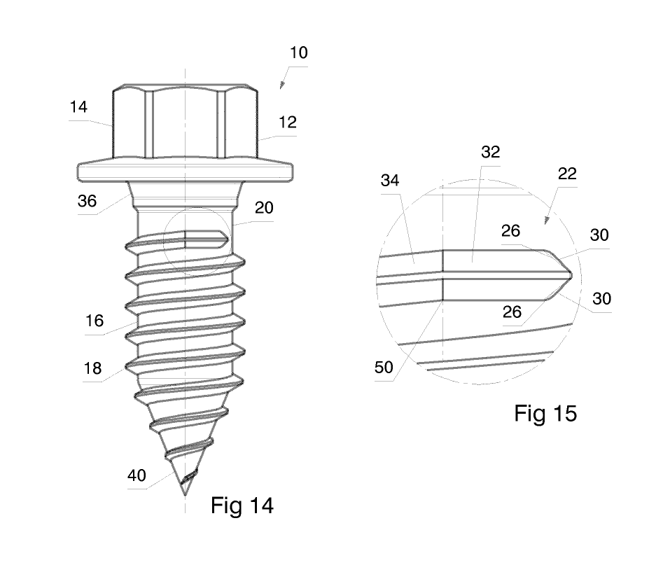

FIG. 14 is a side view of a sixth embodiment of a screw according to the invention. FIG. 15 is a detail from FIG. 14. The screw 12 shown here comprising its screw head 14 that provides an engagement point 12, its shaft 16 that has a thread 18, its thread-free shaft portion 20, its tip 40 and its step 36 between the shaft 16 and the screw head 14 in turn has a particular design with regard to the head end 22 of the thread 18 and to the end plane 32 of the thread 18. The thread 18 tapers towards the screw head 14 at a constant or almost constant pitch as far as a kink 50. After the kink 50, the thread has a smaller pitch as far as its cut-off end 22. In the present case, the thread end has a pitch of 0 after the kink 50. If the thread 19 otherwise has a comparable shape before the kink 50 and after the kink 50, the angle between the screw axis and the end plane 32 is again smaller than the angle between the screw axis and the thread flank 34 at other points. The shoulder 26 on the end 22 of the thread in turn forms the transition to an end face 30, by means of which the thread tapers towards the shaft 16.

Up to now, screws have been described of which the threads have symmetrical thread flanks remote from the thread-free region. However, the invention can also be achieved using screws that have asymmetrical thread flanks

The features of the invention disclosed in the above description, the drawings and in the claims can be essential to the implementation of the invention both individually and in any combination.

### LIST OF REFERENCE NUMERALS

10 screw
12 engagement point
14 screw head
16 shaft
18 thread
20 thread-free shaft portion
22 head end
24 shoulder
26 starting point
28 cutting plane
30 surface
32 end plane
34 thread flank
36 step
38 boring tip
40 tip
42 thin metal sheet
44 outer metal sheet
42 sheet stack/layer stack
44 sheet stack/layer stack
46 insulating material
48 funnel shape
50 kink
52 fastening arrangement

1. A screw, comprising
a screw head (14) provided with an engagement point (12),
a shaft (16) that defines a screw axis and has a thread (18),
a thread-free shaft portion (20) arranged between the thread (18) and the screw head (14), and
a head end (22) of the thread (18) is cut off.

2. The screw (10) according to claim 1, wherein
remote from the thread-free shaft portion (20), the thread (18) has a defined thread depth, and
the head end (22) of the thread forms a shoulder (24) to the shaft that has a maximum radial height at a starting point (26) that is greater than 10% of the thread depth.

3. The screw (10) according to claim 2, wherein the shoulder (24) is defined by a radial cut having an axial cutting plane (28).

4. The screw (10) according to claim 2, wherein, proceeding from the starting point (26) of the shoulder (24), the thread ends in at least one non-radial end face (30) that tapers towards the shaft (16).

5. A screw, comprising
a screw head (14) provided with an engagement point (12),
a shaft (16) that defines a screw axis and has a thread (18),
a thread-free shaft portion (20) arranged between the thread (18) and the screw head (14),
the thread (18) ends adjacently to the thread-free shaft portion (20) in an end plane (32) that surrounds the shaft (16) at least in part at a constant spacing from the screw head (14) and forms an angle α_{E} with the screw axis,
remote from the thread-free shaft portion (20), a head flank (34) of the thread (18) forms an angle α_{F} with the screw axis, and
the angle α_{E} is smaller than the angle α_{F}.

6. The screw (10) according to claim 5, the end plane (32) extends radially.

7. The screw (10) according to claim 5, the thread (18) has a constant pitch when tapering towards the screw head (14) across a plurality of thread turns, and ends at a pitch of 0 after a kink (50).

8. The screw (10) according to claim 5, wherein the thread-free shaft portion (10) has, at least in part, a diameter that is greater than a core diameter of the thread and smaller than an outer diameter of the thread.

9. The screw (10) according to claim 5, wherein the thread-free shaft portion has, at least in part, a diameter that is smaller than or equal to a core diameter of the thread.

10. The screw (10) according to claim 5, wherein the thread-free shaft portion comprises a step (36), adjacent to the screw head, having a shaft diameter that is greater than a core diameter of the thread.

11. The screw (10) according to claim 5, wherein the screw is a drilling screw having a shaft that tapers into a boring tip (38).

12. The screw (10) according to claim 5, wherein the screw is a drive-out screw having a thread that extends into the tip (40) of the drive-out screw.

13. The screw according to claim 5, wherein the thread (18) is a tapping-screw thread.

14. The screw according to claim 5, wherein the thread (18) is a single-start or multi-start thread.

15. A fastening arrangement (40) comprising a layer stack having at least one thin metal sheet (42) and a screw (10) according to claim 5, wherein a thickness of the layer stack corresponds at most to a length of the thread-free shaft portion (20).

16. The fastening arrangement according to claim 15, wherein the thin metal sheet (42) is a layer of the layer stack that is furthest from the screw head (14).

17. The fastening arrangement according to claim 16, wherein the layer that is furthest from the screw head has a maximum thickness of 1 mm.

18. A method of installing a screw (10), comprising providing a screw according to claim 1, and installing the screw externally or internally on a building.

19. The method according to claim 18, further comprising fastening outer or inner metal sheets of sandwich panels with the screw.
